(19) United States
(12) Patent Application Publication
(10) Pub. No.: US 2015/0000613 A1
(43) Pub. Date: Jan. 1, 2015

(54) PET LEASH WITH PADLOCK

(71) Applicant: Diane Cooke, Toronto (CA)

(72) Inventor: Diane Cooke, Toronto (CA)

(21) Appl. No.: 14/378,236

(22) PCT Filed: Feb. 11, 2013
(86) PCT No.: PCT/CA2013/000115

§ 371 Date: Aug. 12, 2014

Related U.S. Application Data
(60) Provisional application No. 61/598,073, filed on Feb. 13, 2012.

(51) Int. Cl. A01K 27/00; E05B 67/06

(52) U.S. Cl. CPC A01K 27/003; E05B 67/06
USPC 119/795; 70/20

(57) ABSTRACT

The present invention is lockable pet leash system employing a padlock having a locking pin that can be retracted to permit the padlock to be connected to a connector, with a combination lock adapted to prevent the pin from being retracted when the lock is locked. The system includes a leash with a padlock at both the collar end and handhold end of the leash and a collar-attachable lock designed to be retrofitted onto a pet collar. The collar padlock can be attached to a loop on a pet collar. The handhold padlock can be attached to a leash connector on the leach to form a loop that can be formed around an anchor, such as a pole, and thereby the leash can be locked to the anchor.

### FIELD OF THE INVENTION

The present invention relates generally to padlocks for use with leashes, and more particularly to pet leashes and leash systems with attached padlocks.

### BACKGROUND OF THE INVENTION

Pet owners, and more particularly dog owners, are often required to control their pets by attaching a leash, such as that shown in FIG. 1, to the pet. Generally the leash attaches to a collar that is placed around the pet's neck. The collar is generally secured around the pet's neck with a buckle. The collar generally has one or more leash connectors, which are often metal loops attached to the collar. The leash usually has a clip 101 attached to one end (the “collar end” 109) that is adapted to attach to a leash connector on the collar. The other end of the leash (the “handhold end” 108) is generally adapted for the pet owner to hold using his or her hand, for example by being formed into a loop 108 as shown in FIG. 1.

Since pets are not allowed into various places, such as many stores, pet owners sometimes need to leave their pets outside unattended. The owner will often attach the handhold of the leash to a fixed object (an “anchor”), such as a fence or pole, which may be done by placing the handhold loop over an upward projection on the anchor or by wrapping the handhold end of the leash around the anchor and tying it. This raises a fear that a passer-by may steal the pet while it is unattended.

Some attempts have been made to design a leash and collar system so that the pet may be securely locked to an anchor. However, these have either been too complex, expensive or unfamiliar to pet owners so that the use of such locking leashes systems has been very limited. For example, such systems typically employ a custom collar that is integrally connected to the leash with a lock built in, rather than allowing collars already owned by the pet owner to be used.

### SUMMARY OF THE INVENTION

It is an object of the invention to provide a padlock adapted for use in a locking pet leash system adapted to allow an owner to securely lock a pet to an anchor, while employing a connecting mechanism for connecting a leash to a collar that is familiar to pet owners. It is a secondary object of the invention to provide a locking leash system that can be used with existing pet collars to allow an owner to securely lock a pet to an anchor.

The present invention provides a padlock comprising:
(a) a shackle having first and second ends, the first and second ends being spaced apart;
(b) a locking pin having a longitudinal axis, a proximal end and a distal end, the locking pin engaging the first end of the shackle, the locking pin having a closed position in which the proximal end of the locking pin abuts the second end of the shackle so that the locking pin and the shackle together form a closed interior region, the locking pin being moveable relative to the shackle along the axis between the closed position and an open position in which the proximal end of the locking pin is spaced apart from the second end of the shackle to create an opening to the interior region; and
(c) a locking mechanism attached to the shackle, the locking mechanism having an unlocked configuration and one or more than one locked configuration,
wherein, when the locking pin is in the closed position and the locking mechanism is configured in one of the locked configurations, the locking pin is maintained in the closed position, and when the locking mechanism is configured in the unlocked position, the locking pin can be moved into the open position and, when in the open position, the locking pin can be moved into the closed position.

A portion of the locking pin including the distal end may be straight, a portion of the shackle may define a channel in the axial direction, the locking pin being disposed partly within the channel, and the locking mechanism may comprise a plurality of tumblers connected to the shackle, the locking pin and tumblers being adapted so that, when the locking pin is in the closed position, the tumblers may be configured in one of the locked configurations, and when the tumblers are configured in the unlocked position, the locking pin can slide into the open position.

The second end of the shackle may be further from the first end of the shackle than is the proximal end of the locking pin, so that when the locking pin is moved from a closed position to an open position, the locking pin slides further into the channel. Alternatively, the proximal end of the locking pin may be further from the first end of the shackle than is the second end of the shackle, so that when the locking pin is moved from a closed position to an open position, the locking pin slides further out of the channel.

Each tumbler may be rotatably attached to the shackle, each tumbler may further comprise at least one notch on an inner wall of the tumbler, the locking pin may have a protrusion for each tumbler, the protrusions being aligned along the axis of the locking pin so that the protrusions align with the notches in the tumblers when the tumblers are in the unlocked configuration, and subsequent rotation of one or more than one tumbler, when the locking pin is in the closed position, configures the locking mechanism into one of the locked configurations.

The padlock may further comprise a biasing mechanism for biasing the locking pin towards the closed position. The channel may have a proximal end nearer the second end of the shackle, and a distal end further from the second end of the shackle, the shackle may further comprise an end wall at the distal end of the channel, and the biasing mechanism may comprise a spring having two ends, the spring being aligned along the axis and having one end in contact with the end wall of the channel and the other end in contact with the distal end of the locking pin.

The locking pin may be straight.

The invention further provides a lockable leash comprising a leash and a collar padlock as herein described, the leash having a collar end and a handhold end, wherein the collar end of the leash is attached to the collar padlock.

The lockable leash may further comprise a leash padlock. The leash padlock may be a variant of the collar padlock or may be identical to the collar padlock, wherein the leash padlock is attached to the leash. The leash padlock may be attached to the handhold end of the leash.

The lockable leash may further comprise a leash connector attached to the leash, the leash connector defining an interior closed region, and wherein a portion of the leash connector is adapted to fit through the opening to the interior region of the leash padlock when the leash padlock is in the open position.

The lockable leash may further comprise a plurality of leash connectors attached to the leash and spaced apart from each other, each leash connector defining an interior closed region, and wherein a portion of each leash connector is adapted to fit through the opening to the interior region of the leash padlock when the leash padlock is in the open position.

The lockable leash may further comprise a leash connector adapted to slide along the leash surrounding the leash between the collar padlock and the leash padlock, the leash connector being a closed metal loop having an interior region sized to prevent the leash connector from moving past either padlock attached to the leash.

The leash may be made of a cut-resistant material.

The leash may be a metal chain comprising links. At least one link may comprise a portion adapted to fit through the opening to the interior region of the leash padlock when the leash padlock is in the open position. Each link may comprise a portion adapted to fit through the opening to the interior region of the leash padlock when the leash padlock is in the open position.

The invention further provides a lockable leash system comprising the lockable leash herein described and a collar-attachable lock adapted to be attached to a pet collar or a pet harness. The lockable leash system may alternatively comprise a lockable leash as herein disclosed and a lockable pet collar. The lockable leash system may alternatively comprise a lockable leash as herein disclosed and a lockable pet harness.

### BRIEF DESCRIPTION OF THE DRAWINGS

FIG. 1 is a perspective view of a prior art pet leash.

FIG. 2 is a side view of an embodiment of a padlock in a closed position.

FIG. 3 is a perspective view of the padlock shown in FIG. 2.

FIG. 4 is a side view of another embodiment of a padlock, with the coverplate removed, in a closed position.

FIG. 5 is a side view of the padlock shown in FIG. 4, with the coverplate removed, in an open position.

FIG. 6 is an exploded view of the padlock shown in FIG. 4 showing the components of the lock assembly.

FIG. 7 is a perspective view of a tumbler containing a keyway.

FIG. 8 is a perspective view of a keyway.

FIG. 9 is a perspective view of a locking pin.

FIG. 10 is a perspective view of a locking pin inserted through three keyways in an unlocked configuration.

FIG. 11 is a side view of one embodiment of a collar-attachable lock in a closed position.

FIG. 12 is a side view of the collar-attachable lock of FIG. 11 in an open position.

FIG. 13 is a perspective view of another embodiment of a collar-attachable lock in an open position.

FIG. 14 is a perspective view of the collar-attachable lock of FIG. 13 in a closed position.

FIG. 15 is a side view of the collar-attachable lock of FIG. 13 in a closed position.

FIG. 16 is a side view of another embodiment of a padlock.

FIG. 17 is an exploded view of the padlock of FIG. 16.

FIG. 18 is another exploded view of the padlock of FIG. 16.

FIG. 19 is a top view of a collar-attachable lock.

FIG. 20 is a side view of the collar-attachable lock of FIG. 19.

FIG. 21 is a perspective view of a collar with the collar-attachable lock of FIG. 19 attached thereto.

FIG. 22 is an exploded perspective view of the collar-attachable lock of FIG. 19.

FIG. 23 is an exploded perspective view of a portion of the collar-attachable lock of FIG. 19 without one side of the casing.

FIG. 24 is a top view of the internal components of the collar-attachable lock of FIG. 19.

FIG. 25 is a side view of the internal components of the collar-attachable lock of FIG. 19.

FIG. 26 is an exploded perspective view of the internal components of the collar-attachable lock of FIG. 19.

FIG. 27 is a side view of the collar-attachable lock of FIG. 19 without one side of the casing.

### DETAILED DESCRIPTION OF THE INVENTION

### Prior Art

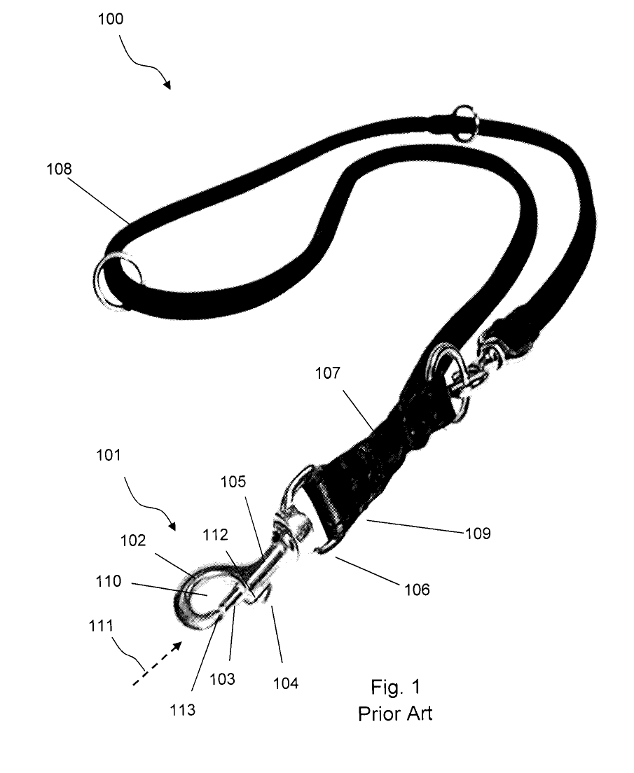

A typical prior art pet leash 100 for use with a dog or other type of pet is shown in FIG. 1. The leash has a handhold end 108 formed in a loop for the owner to hold, and a collar end 109 that is attached to a clip 101. Such clips may vary in shape, but are generally similar to the clip 101 shown in FIG. 1, having a rounded shackle hook 102 attached to a shackle body 105 that is attached to the leash body 107 using a leash connecter 106. The shackle has a first end 112 at the top of the shackle body 105 and a second end 113.

The shackle body 105 defines an internal channel, having a longitudinal axis 111, for receiving a pin 103 that is biased into a closed position by a spring in contact with the distal end of the pin 103, the spring being contained inside the channel in contact with an end wall of the channel. In the closed position, the proximal end of the pin 103 abuts the second end 113 of the shackle hook 102, and the shackle hook 102 and visible portion of the pin 103 together define a closed interior region 110 as shown in FIG. 1.

The pin 103 extends inside the channel and can be retracted further into the channel by applying force in the axial direction 111 towards the leash 109 to a protrusion 104 adapted for that purpose to compress the spring between the distal end of the pin 103 and the end wall of the channel. The protrusion 104, which is rigidly attached to the pin 103, slides axially along a slot in the shackle arm 105, which is a straight opening between the channel and the outside along one side of the shackle arm 105 in the axial direction, the slot having a width sized to accommodate a member connecting the protrusion 104 to the pin 103 inside the channel. When retracted into an open position, an opening to the interior region 110 is created so that the clip can be connected to a loop on the pet's collar by positioning the clip 101 while in the open position so that a portion of the loop is inside the interior region 110 and then removing the force on the protrusion 104 so that the biasing mechanism pushes the pin 103 to close the opening.

The type of clip 101 shown in FIG. 1 is widely used, although the shape may vary, and variants of this design can be found in a high percentage of pet leashes in use today. The present invention provides a lockable clip that operates substantially the same way as do such prior art clips 101 but also incorporates the capability to lock the clip in a closed position.

### Padlock

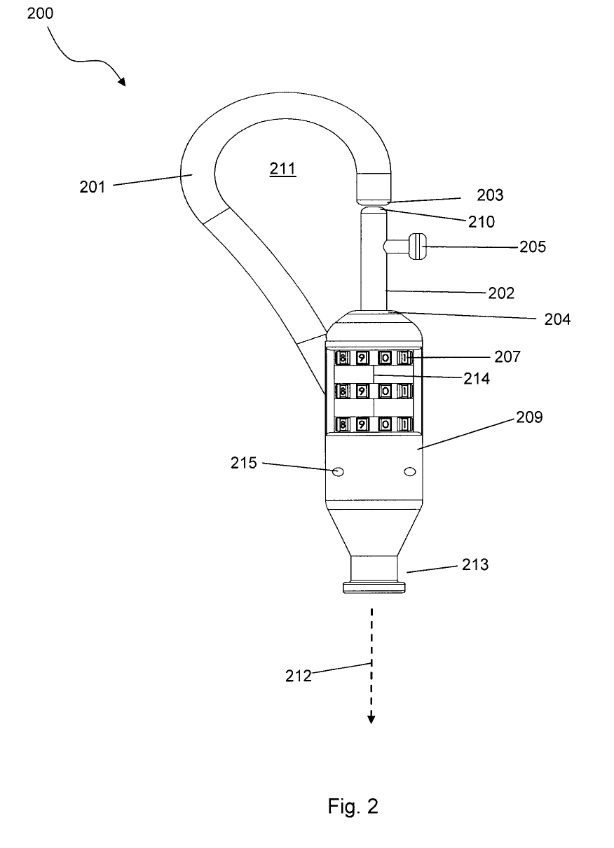

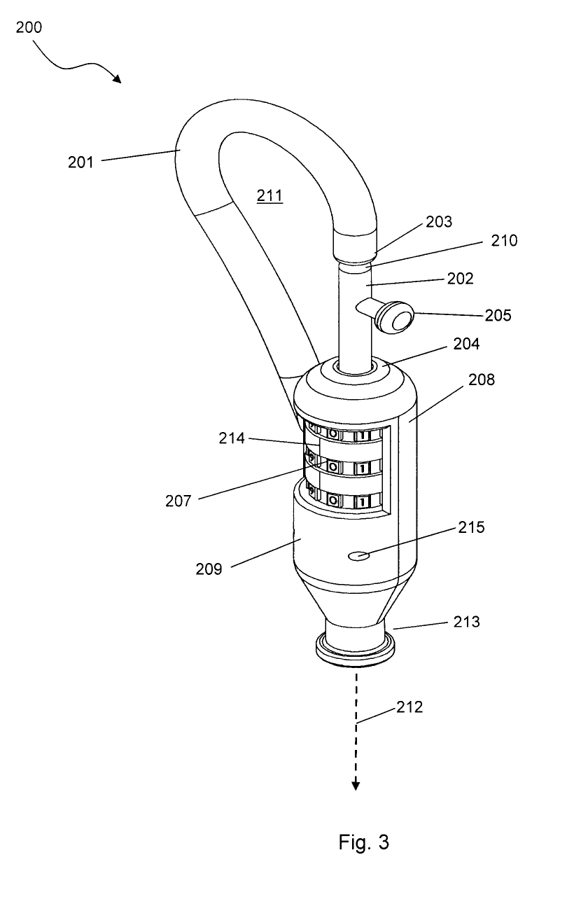

One embodiment of a padlock 200 is shown in a closed position in FIGS. 2 and 3. It includes three main components: (1) a shackle comprising a hook 201 and a body 208, (2) a locking pin 202, and (3) a locking mechanism including tumblers 207. The tumblers 207 are rotatable around the locking pin 202 and attached to, or fixed in position along the horizontal axis 212 by, the shackle body 208.

The shackle has a first end 204 at the top of the shackle body 208, and a second end 203 at the end of the hook 201, the second end 203 being spaced apart from the first end 204. The first end 204 is the highest point on the shackle that touches, or engages, the locking pin 202. In some embodiments this point may be on the hook 201, and in others, as in those shown in FIGS. 2-5, it is at the top of the shackle body 208.

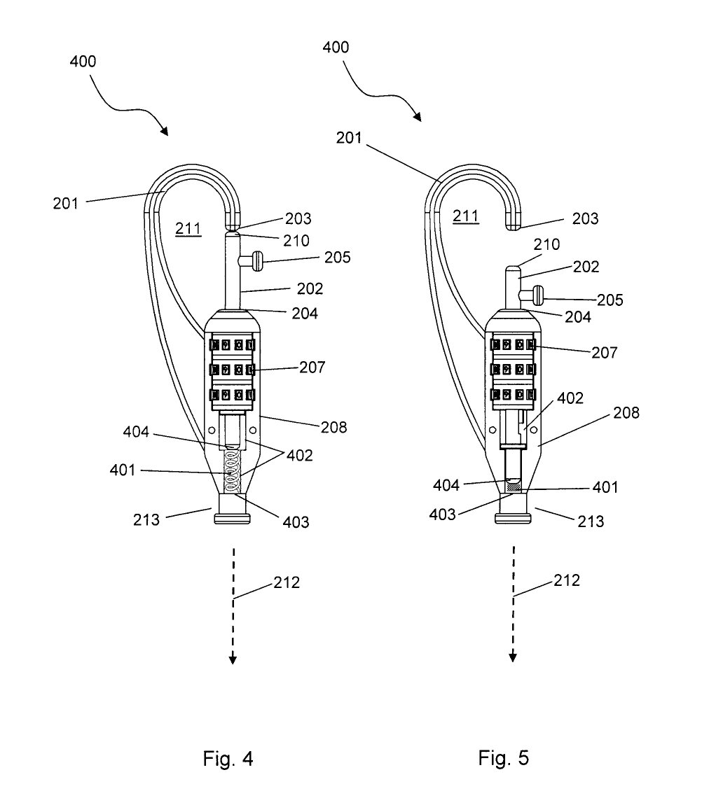

The shackle body 208 and locking pin 202 share a longitudinal axis 212. The shackle body 208 and locking mechanism define an internal channel 402 in the axial direction 212, designed for receiving the locking pin 202. The locking pin 202 is partly disposed inside the channel 402 at all times. The channel 402 and locking pin 202 are generally cylindrical, although the diameter of the channel 402 may vary, as can be seen in FIG. 4 where the lower part of the channel 402 containing the spring 401 is relatively narrow, having a diameter approximately equal to or slightly larger than the diameter of the locking pin 202. In the closed position, shown in FIGS. 2, 3 and 4, the proximal end 210 of the locking pin 202 abuts the second end 203 of the shackle, and the locking pin 202 engages the first end 204 of the shackle 201 so that the shackle and locking pin 202 together form a closed interior region 211.

The locking pin 202 may have a thumb button 205 rigidly attached to the locking pin 202 to facilitate opening the lock.

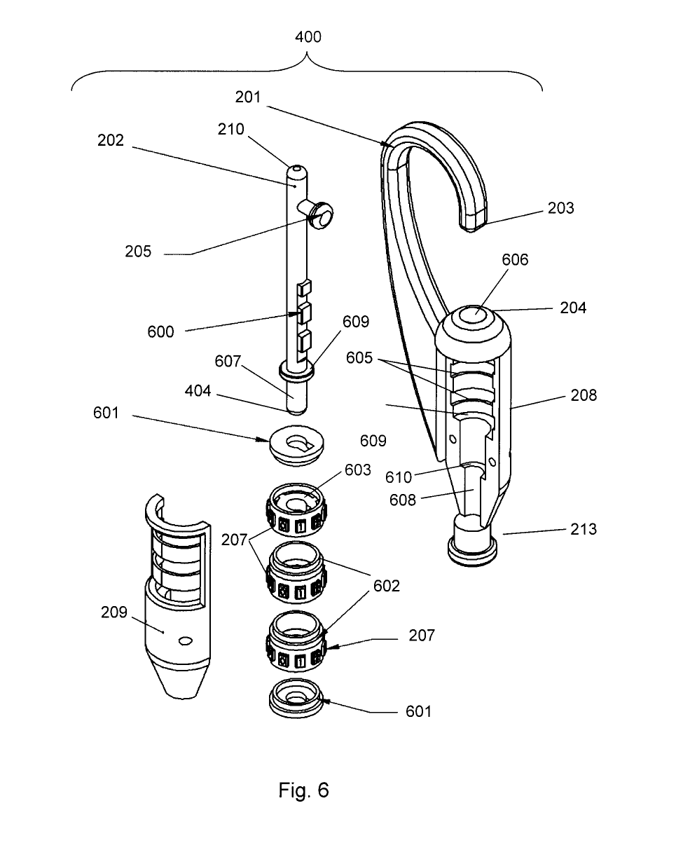

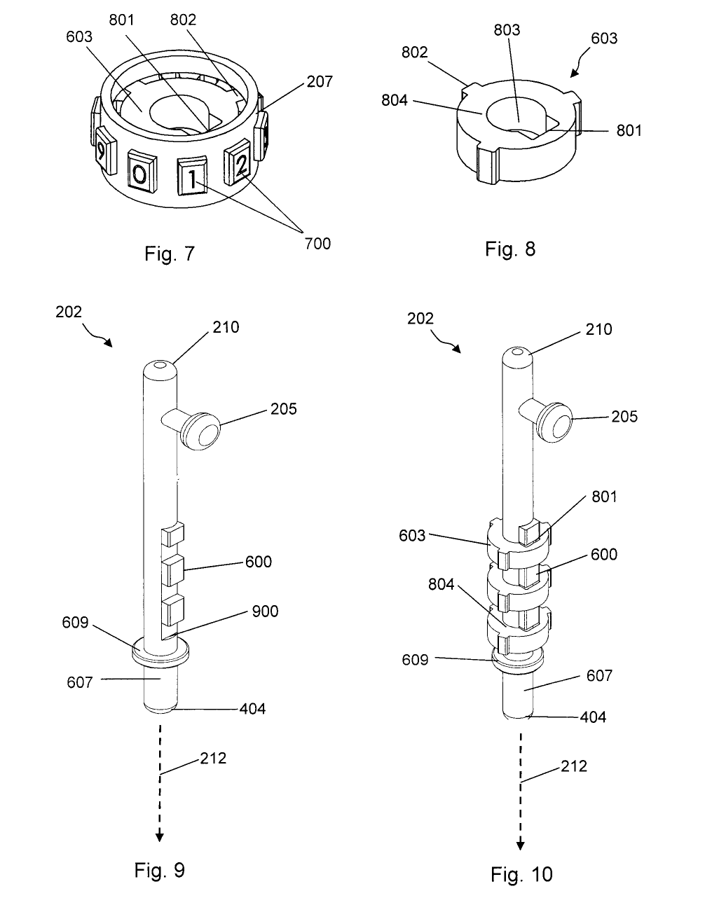

In the depicted embodiments, the tumblers 207 rotate around the locking pin 202 so that they can be configured in an unlocked configuration or a locked configuration. The tumblers 207 can be best seen in the exploded view of FIG. 6 and in FIG. 7, which shows a single tumbler 207 with a keyway 603 inside it. The tumbler 207 with a keyway 603 may alternatively be a single unit, which is also referred to as a tumbler. A keyway 603 is shown by itself in FIG. 8.

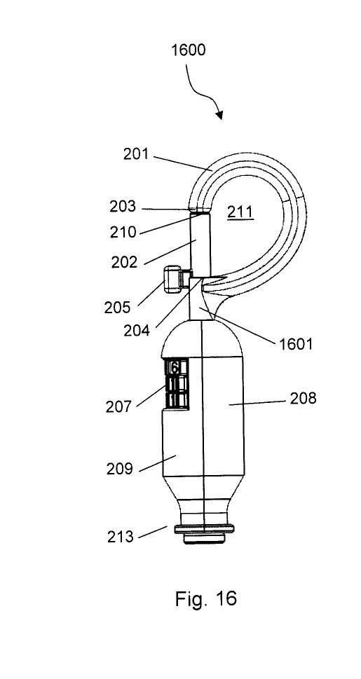

The shackle body 208 alone may define the channel 402, but when the tumblers 207 are rotatable about the locking pin 202 then the interior 803 of the tumblers 207 may also comprise portions of the channel 402 defined by the interior vertical walls of the tumblers 207, or of the keyways 603, that delimit the interior space 803. In other embodiments, such as those described below in relation to FIGS. 16-18, the channel may be formed by a sleeve that is part of the shackle.

As shown in FIGS. 6, 9 and 10, the locking pin 202 may have a plurality of locking protrusions 600 attached to it where the locking protrusions 600 are aligned in the axial direction and sized to fit through the notches 801 in the keyways 603. The particular embodiments shown in the figures employ three protrusions 802 to facilitate attaching each tumbler 207 to the keyway 603. Each keyway 603, or tumbler, has a notch 801 on its inner wall, shaped and sized to receive a locking protrusion 600 on the locking pin 202, as can be seen in FIGS. 9 and 10. The width of the notch 801 is generally at least as large as, and preferably slightly larger than, the width of the protrusions 600. The locking pin 202 has at least one such protrusion 600 for each tumbler 207, spaced apart by the height of the keyways 603. An extra protrusion 900 below the lower-most tumbler may also be employed, but is not required. The height of each keyway 603 is generally no greater than, and preferably slightly less than, the distance between the protrusions 600. It is preferred that the protrusions 600 be regularly spaced so that multiple tumblers 207 and keyways 603 of the same size can be used, but this is not essential.

FIG. 10 shows a locking pin 202 with three keyways 603 attached to it in an unlocked configuration where the notches 801 are aligned in the axial direction 212 with the locking protrusions 600 so that the locking pin 202 may slide through the keyways 603 when they are held in a fixed position by the shackle body 208. Note that although three protrusions 600 and tumblers 207 are shown in the figures, the invention could employ 2, 4 or more tumblers and protrusions 600. A single tumbler 207 and a locking pin with two protrusions could be employed, but would not result in a secure lock.

In the unlocked configuration, if any of the tumblers 207 is rotated by less than 360 degrees, the padlock 200, 400 is then configured in a locked configuration and the locking pin 202 is prevented from moving in the axial direction 212 because at least one of the protrusions 600 abuts the top 804 of a keyway 603 and/or the bottom of another keyway 603, and the tumblers 207 and keyways 603 are prevented from moving in the axial direction 212 by the shackle body 208. When the tumblers 207 are rotated so as to be configured into an unlocked configuration, the locking pin 202 may then slide in the axial direction 212 further into the channel 402 to create an opening between the proximal end 210 of the locking pin 202 and the second end 203 of the shackle, as shown in FIG. 5, because the notches 801 in the keyways 603 align with the protrusions 600 and permit them to slide past the keyways 603. This can be seen in FIGS. 4 and 5, which show a side view of an embodiment of a padlock with the coverplate 209 removed and the portions of the shackle defining the channel 402 made transparent.

The coverplate 209 is part of the shackle body 208, and could be integrally formed with it. For simplicity of manufacturing, a separate coverplate 209 that is securely attached by rivets, or other tamper-resistant fasteners, 215 to the rest of the shackle body 208 is preferred.

An example embodiment is shown in an exploded view in FIG. 6. The tumblers 207 are attached to each other by intermediate washers 602. Top and bottom washers 601, attached to the top and bottom tumblers 207 respectively, abut internal portions of the shackle body 208, when the lock is assembled, to prevent any significant movement of the assembled locking mechanism, the locking mechanism including the tumblers 207 and washers 601 and 602, in the axial direction 212. For example, the inside of the shackle body 208 may narrow at a point chosen to create a shelf 604 to abut the bottom washer 601, and a similar narrowing point may be employed at a higher point so that upper and lower shelves are spaced apart by the height of the assembled locking mechanism, or slightly more than the height of the assembled locking mechanism. The diameter of the internal portion of the shackle body 208 is sufficient to contain the assembled locking mechanism. Each tumbler 207 may be further constrained in a fixed axial position by variations 605 in the diameter of the internal portion of the shackle body 208 so that it narrows slightly immediately above and below each tumbler 207.

The channel 402 extends from a top opening 606, which in the embodiments shown in FIGS. 2-6, is coincident with the first end 204 of the shackle, to an end wall 403 of the channel 402. The diameter of the channel 402 at the points in the interior 803 of the keyways 603, is approximately equal to or slightly larger than the diameter of the locking pin 202 so that the horizontal axes 212 of the shackle body 208 and locking pin 202 remain approximately coincident. The diameter of the channel 402 at the top opening 606 and near the end wall 403 is generally also approximately equal to or slightly larger than the diameter of the locking pin 202 to further ensure that the horizontal axes 212 of the shackle body 208 and locking pin 202 remain approximately coincident.

The locking pin 202 may have a collar 609 extending horizontally from, and extending around, the body of the locking pin 202. The shackle body 208 may then have a lower shelf 610 formed by narrowing the diameter of the channel 402 at that point so that the collar 609 limits how far the locking pin 202 can extend into the channel 402 because it cannot go past the point at which the bottom side of the collar 609 abuts the shelf 610.

In preferred embodiments, a mechanism (not shown in the figures) is included to prevent the locking pin 202 from rotating relative to the shackle body 208. For example, the lower portion 607 of the locking pin 202 extending from the collar 609 to the distal end 404 of the locking pin 202 may have a vertical protrusion, with a constant, relatively narrow, width, extending out from it panning the lower portion 607 of the locking pin 202. The portion of the shackle body 208 forming the lower portion 608 of the channel 402 would then be made to be sufficiently longer than the lower portion 607 of the locking pin 202 to accommodate the compressed spring 401 beneath the locking pin 202 when the bottom side of the collar 609 abuts the shelf 610, and have a notch extending vertically over the length of the lower portion 608 of the channel 402 having a width approximately equal to or slightly larger than the width of the vertical protrusion on the lower portion 607 of the locking pin 202. In such embodiments, the length of the locking pin would be somewhat larger than shown in FIG. 4 so that a portion of the locking pin is contained in the lower portion 608 of the channel 402 when the locking pin 202 is in the closed position to ensure that a portion of the vertical protrusion on the lower portion 607 of the locking pin 202 is inside the notch in the lower portion 608 of the channel 402 at all times. Such a pin rotation prevention mechanism is not essential, but in its absence, a user may need to occasionally adjust the rotational position of the locking pin 202, for example by aligning the thumb button 205 with mark on the outside of the shackle body 208.

Generally, when a pin rotation prevention mechanism is employed, there is a single unlocked configuration in which the notch 801 on the inner wall of each keyway 603 aligns with the locking protrusions 600, and all other configurations of the tumblers 207 are locked configurations. The locking pin 202 is generally biased towards the closed position by a spring 401 located inside the channel 402 that engages the distal end 404 of the locking pin 202 and the end wall 403 of the channel 402, and is aligned in the axial direction 212. The padlock 200 can be moved into the open position by applying force in the axial direction 212 to the locking pin 202 via the thumb button 205 towards the distal end 404 of the locking pin 202 to cause the locking pin 202 to slide further into the channel 402 so that the second end 203 of the shackle and the proximal end 210 of the locking pin 202 are separated to form an opening to the interior region 211. As shown in FIG. 5, this causes the spring 401 to compress so that when the force is removed the padlock 400 returns to the closed position. The spring 401 is designed so that it continues to apply an upward force to the distal end 404 of the locking pin 202 in the closed position so that the padlock 400 remains in the closed position in the absence of another greater force pushing the locking pin 202 down in the axial direction 212.

When in the open position, the padlock 200, 400 may be moved so that a portion of a loop connector is inside the interior region 211 and then the force on the thumb button 205 may be removed to allow the spring 401 to bias the locking pin 202 back into the closed position, closing the opening to the interior region 211 so that the padlock 200, 400 cannot be removed from the loop connector without opening the padlock 200, 400. When the tumblers 207 are then rotated so that the padlock is in a locked configuration, the padlock cannot be opened (i.e. the locking pin 202 cannot be moved into an open position) by applying force to the locking pin 202.

Typically the tumblers have a fixed number of marked positions, such as 10, with numbers 700 on the outside corresponding to each position, and the configuration corresponding to the unlocked configuration is achieved when the three tumblers, read from top to bottom for example along a marked radial position 214, correspond to a particular sequence of three digits, such as 2-8-3, which is referred to as the “combination” of the padlock 200, 400.

The depicted locking mechanism is just one example of a suitable mechanism that may be employed. In general, any mechanism configurable in locked and unlocked configurations that, when in a locked configuration, prevents the locking pin 202, when in a closed position, from sliding further into the channel 402 would suffice. For example, a mechanism that could be used, but is not preferred, employs a horizontal hole, perpendicular to the axial direction 212, through the locking pin that aligns with horizontal holes through the shackle body 208 when the padlock is in the closed position so that a portion of the shackle of a standard off-the-shelf padlock may be placed though the holes and locked to maintain the locking pin 202 in the closed position. Many other variants will be evident to skilled persons.

There is no need for the locking pin to be straight as shown in the figures. For embodiments employing an extended straight channel, a portion of the pin that can be retracted into the channel needs to be straight, the straight portion having a length at least equal to the size of the opening that is formed when the padlock is in the open position, and sufficiently long to accommodate the portion containing any protrusions, or other features, required to mate with the locking mechanism. The top portion of the locking pin, which does not enter the channel, could be curved and/or have straight portions at non-zero angles relative to each other.

There is also no need for the shackle hook 201 to be curved. A simple variant of the embodiment shown in the figures could employ a semi-rectangular or semi-triangular shackle with all portions being straight.

It is not necessary that the first end 204 of the shackle 402 be coincident with the top of the channel 606. In some embodiments, such as that shown in FIGS. 16-18, the portion of the shackle immediately above the locking mechanism may be straight and vertical for a portion that runs along a vertical portion of the locking pin above the top of the channel 606 until the point (being the first end 204 of the shackle) where one or both of the hook and locking pin curve or otherwise fall away from the other so as to form the lower portion of the interior region 211.

It is also not essential that the thumb button always be above the channel as depicted in the figures. For example the channel could extend above the locking mechanism and include an axial slot through which a portion of the thumb button passes, as in the prior art shown in FIG. 1 and as shown in the embodiment depicted in FIGS. 16-18.

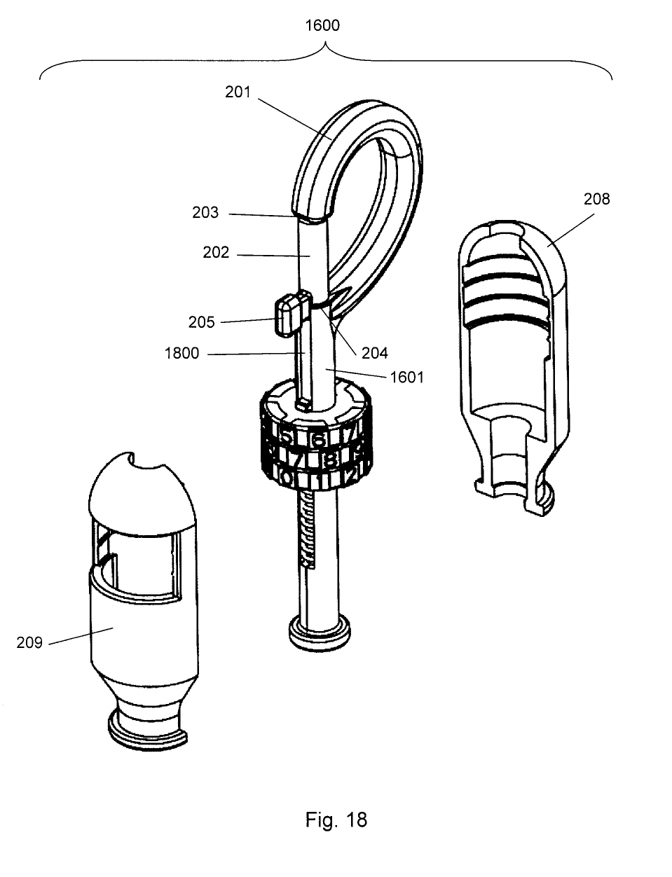

FIGS. 16-18 depict a preferred embodiment of a padlock 1600. Note that the same numbers are used in FIGS. 16-18 to identify portions of the padlock 1600 as are used in FIGS. 2-10 for the corresponding elements of the padlocks 200, 400 although the elements of the embodiments differ somewhat, as shown in FIGS. 16-18. This embodiment employs a sleeve 1601 attached to the hook 201 and forming a portion of the shackle, extending downward from the first end 204 of the shackle. The sleeve 1601 defines an internal channel in the axial direction 212 for receiving the locking pin 202 that is sized to fit the diameter of the locking pin 202. When the padlock 1600 is assembled, the sleeve 1601 defines an axial slot 1800, as can best be seen in FIG. 18. In the depicted embodiment, two portions of the sleeve 1601 are designed to rotate with respect to the axis 212 to facilitate assembly. The thumb button 205 is rigidly connected to the locking pin 202 by a shaft that is sized to fit through the slot 1800 in the sleeve 1601 when the padlock 1600 is assembled so that the thumb button 205 can be pushed downward to compress the spring 401 and retract the locking pin 202 further into the channel. The thumb button 205 may be located so that its connecting shaft is always maintained partly within the axial slot 1800 in order to prevent rotation of the locking pin 202. The protrusions 600 that are aligned axially along the locking pin 202 also protrude through the axial slot 1800 and so prevent rotation of the locking pin 202.

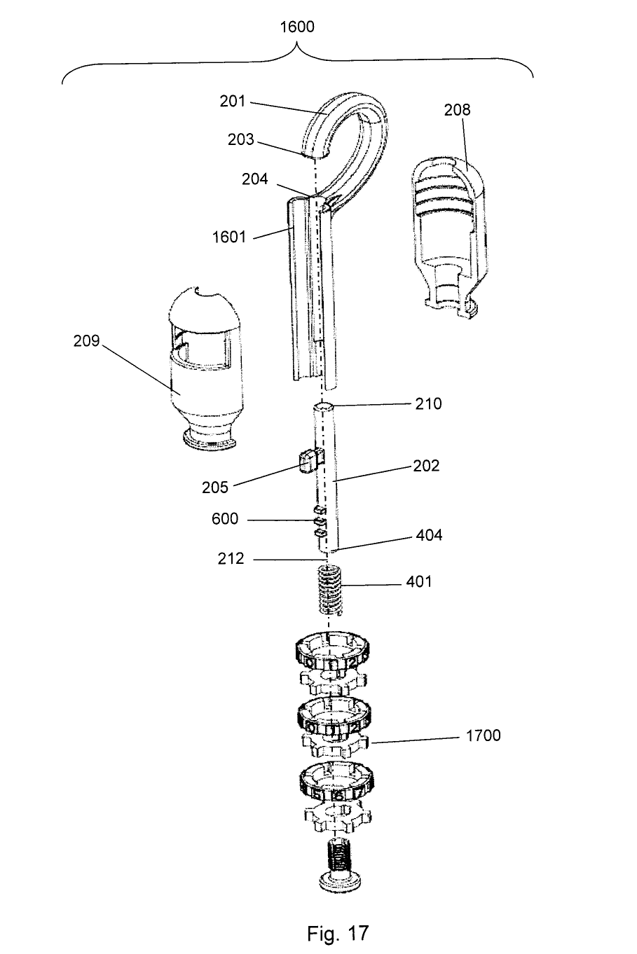

FIG. 17 shows a fully exploded view of the padlock 1600. This embodiment also employs keyways 1700 that differ from the keyway 603 shown in FIG. 8 in the number of protrusions employed. FIG. 18 shows a partially exploded view of the padlock 1600 with the locking pin 202 inside the sleeve 1601, which is surrounded by the keyways 1700 and tumblers.

It is also not necessary that the locking pin move downward in the axial direction 212 when moving from the closed to the open position. For example, if the portion of the locking pin outside the channel is formed in a hook shape so that the proximal end of the locking pin is above the second end of the shackle hook (i.e. the proximal end of the locking pin is further from the first end of the shackle than is the second end of the shackle), then the locking pin would have to be moved in the opposite direction in order to move from the closed position to the open position. In such embodiments, the biasing mechanism, if employed, would be designed to produce a downward force on the distal end of the locking pin when it is in the closed position, rather than an upward force as in the embodiments shown in the figures.

The entire shackle could be one straight piece in embodiments where the top portion of the locking pin is curved so that it curves around to meet the second end of the shackle from above and form a closed interior region.

It is also not essential that a thumb button be employed. Other mechanisms could be employed to allow a user to open the padlock. Anything that allows a user to apply a force in the axial direction could be employed. For example, the locking pin could just have a rough or ridged surface so that a user can grasp it and pull the pin further into the channel. Alternatively, a piece having a decorative shape, such as of a bone, could be attached to the locking pin, while leaving the tumblers exposed in the vicinity of the marked positions to allow the tumblers to be rotated and the combination to be read, so that the bone-shaped piece is rigidly attached to the locking pin but can move along the longitudinal axis with the locking pin so that a user can push the bone-shaped piece down towards the distal end of the channel to move the padlock into an open position. Although it is not preferred, some embodiments may include no special mechanism to apply force to the locking pin, which would then need to be grasped directly between two fingers and then pushed down or lifted up to open or close the lock.

It is also not essential that a biasing mechanism be employed, although it is preferred. Without a biasing mechanism, the locking mechanism would generally need to be kept in a locked configuration in order to maintain the locking pin in a closed position.

The padlock 200, 400, 1600 can be made from any materials generally used to construct standard padlocks, with a metal, such as stainless steel, iron, or brass, preferred for at least the shackle, locking pin 202 and keyways 603. The tumblers can also be made from metal or may comprise plastic, for example. The entire padlock could be made from plastic, but this is not preferred.

### Locking Leash

The padlock 200, 400, 1600 includes a means to connect it to a leash, the leash being preferably made of a cut-resistant material, such as metal. Alternatively, leather or plastic can be employed, for example, or other materials generally used for pet leashes. Alternatively the interior of the leach may be made of a strong, cut-resistant, material. For example a steel cable could be employed, surrounded on the outside by leather. Any other flexible material with a core of steel cable running through it would also be suitable.

The embodiments shown in the figures include a connecting end 213 adapted to be attached to a leash connector that is securely attached to a padlock 200, 400, 1600. The leash connector may be any suitable connector, such as a metal ring 106 to which an end of the leash may be securely attached. In the case of a leash with a steel core, the steel core is preferably securely attached to the leash connector. A single lock leash may then be formed, for example, by replacing the clip 101 in FIG. 1 with a padlock 200, 400, 1600. The padlock 200, 400, 1600, which may be referred to as a collar padlock, can then be attached to a collar connector on a pet collar.

A collar connector may be a loop of metal, at least a portion of which has a diameter smaller than the size of the opening to the interior region 211 when the padlock 200, 400, 1600 is in the open position. Such connectors may be directly attached to a pet collar to permit the padlock 200, 400, 1600 to attach to the collar. Alternatively, a connector may be a ring, or other loop, surrounding a pet collar.

In a preferred embodiment, the locking leash includes a second padlock 200, 400, 1600, which may be referred to as a leash padlock, and at least one leash connector connected to or surrounding the leash. The second padlock may be attached to the handhold end of the leash so that the handhold end of the leash may be wrapped around an anchor, such as a tree or a pole, and then connected to the leash connector on the leash, thereby locking the leash to the anchor. The leash connector may surround the leash and be moveable and adapted to slide along at least a portion of the leash between the collar padlock and the leash padlock so that the leash can be locked to anchors of varying sizes. For example, the leash connector may be a closed metal loop having an interior region sized to prevent the leash connector from moving past either padlock attached to the leash. Alternatively, there may be a plurality of leash connectors attached to different points in fixed positions along the leash. Alternatively, the leash may be, at least in part, a metal chain having links, where at least one link comprises a portion adapted to fit through the opening to the interior region of the leash padlock when the leash padlock is in the open position. Preferably all links are so adapted to provide for the widest range of anchor sizes to which the leash may be locked.

In some embodiments, the leash may have one or more leash connectors at distances of, for example, about 15 to 30 centimetres from the handhold end of the leash, which are designed to be used to attach to the leash padlock that is attached to the handhold end of the leash. When so attached, the portion of the leash between the leash connector and the leash padlock forms a loop that can be used as a handhold.

Alternatively, the second padlock may be attached to the leash by a connector ring that is adapted to slide along the leash, and the handhold end of the leash has a loop connected to it, or formed by it, adapted to fit through the opening to the interior region of the leash padlock when the leash padlock is in the open position. In such embodiments, the second lock may be adapted to removably attach to the collar padlock, or to another portion of the leash, so as to secure it while the leash is not locked to an anchor.

While it is preferred that the leash padlock be identical to the collar padlock, this is not essential. For example, the leash padlock could be any suitable lock adapted to lock to a leash connector, but is preferably a variant of the padlocks herein described.

### Locking Leash and Collar System

The invention further comprises a collar-attachable lock or a lockable collar to form a lockable leash system comprising a leash, a collar padlock attached to the leash, as described above, and either a collar-attachable lock or a lockable collar. The lockable leash system further optionally comprises a leash padlock attached to the leash as described above.

The collar-attachable lock may be attached to existing pet collars so that the collar can be locked around the pet's neck. When a locking leash with two padlocks and a lockable collar are employed, the invention can be used to securely lock a pet to an anchor with three locking points: (1) the collar being locked to the pet's neck, (2) the leash being locked to the collar via the collar padlock, and (3) the leash being locked to an anchor via the leash padlock.

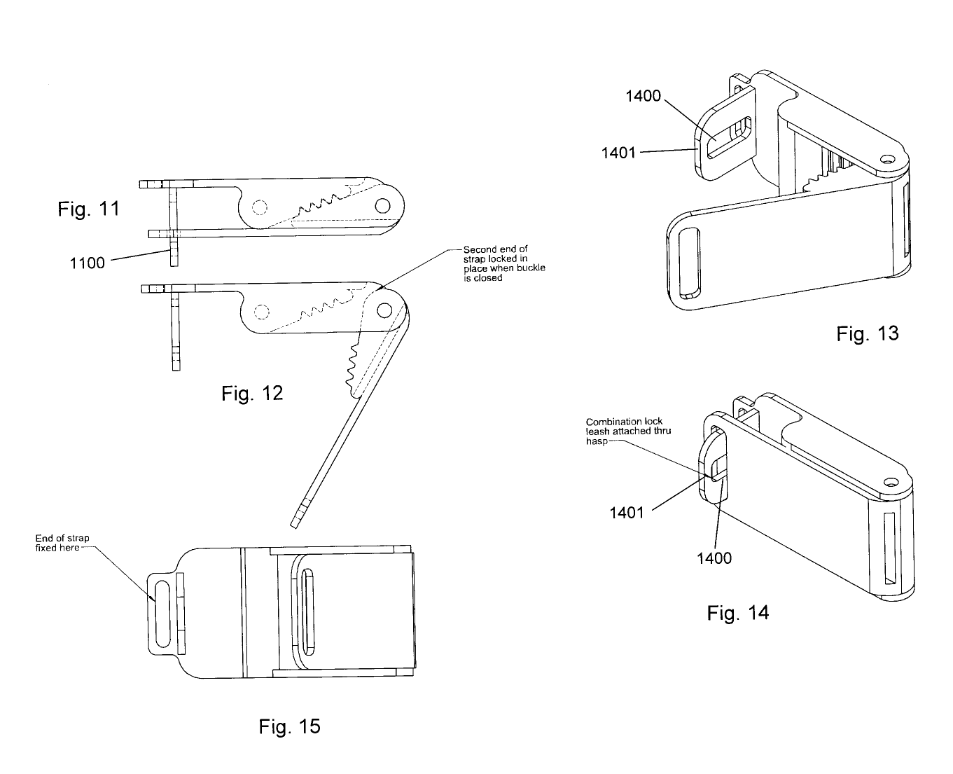

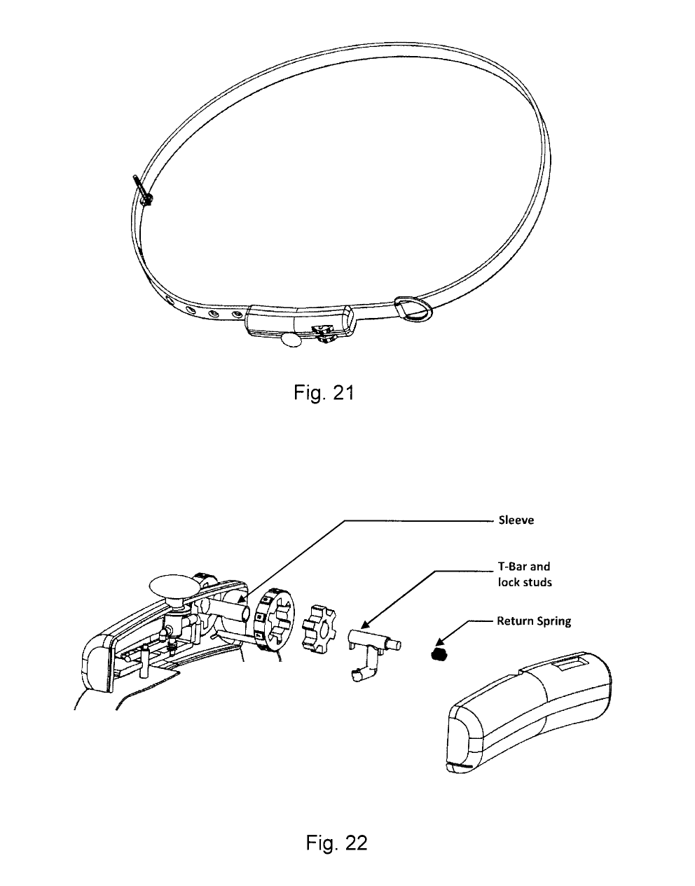

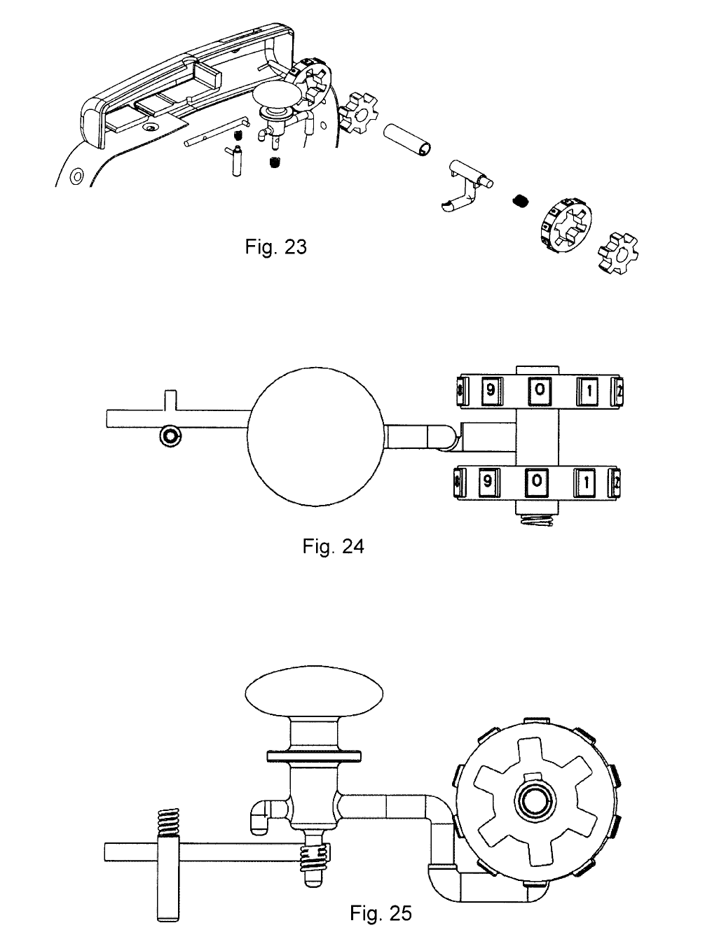

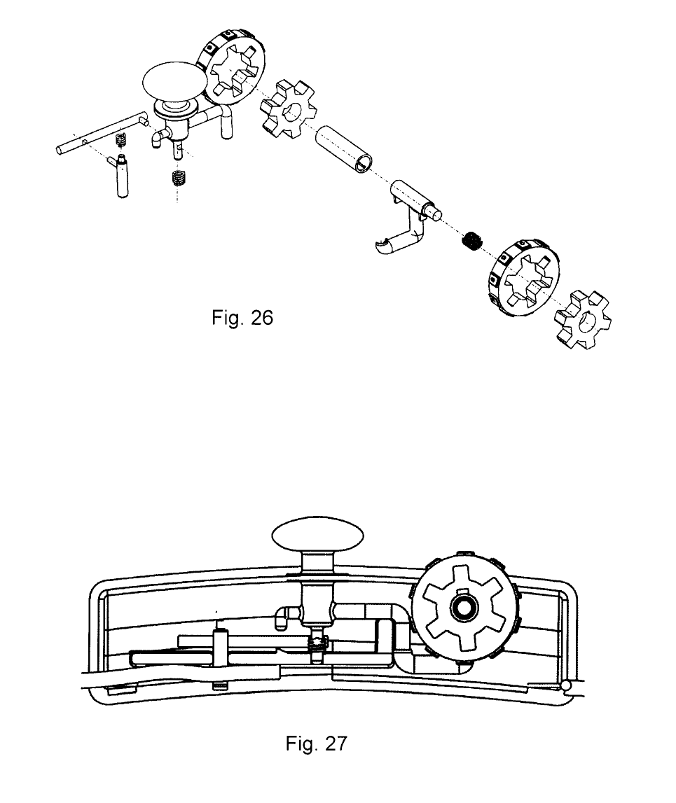

Embodiments of collar-attachable locks are shown in FIGS. 11-15 and 19-27.

One embodiment of a collar-attachable lock is shown in FIG. 11 in a closed position and in FIG. 12 in an open position. A pet collar passes through the collar-attachable lock when it is in the open position, and, in the closed position it maintains the collar in a fixed position, and provides an opening 1100 that acts as a collar connector so that it may be locked by attaching the collar padlock to the opening 1100 by passing the second end of the shackle through the opening 1100 when the lock is in an open position, moving the lock into the closed position, and locking the padlock.

Similarly FIGS. 13 and 14 depict another embodiment of a collar-attachable lock that can be closed to secure the collar, and then the collar padlock can be attached to an opening 1400, or hasp, to maintain the collar-attachable lock in a closed position. This is done by closing the collar-attachable lock (to the position shown in FIG. 14), moving the collar padlock into an open position, moving the collar padlock until the second end 203 of the hook 201 passes through the opening 1400, moving the collar padlock into the closed position, and configuring the lock in a locked configuration so that a portion 1401 of the collar-attachable lock surrounding the opening 1400 is inside the closed interior region 211 of the collar padlock.

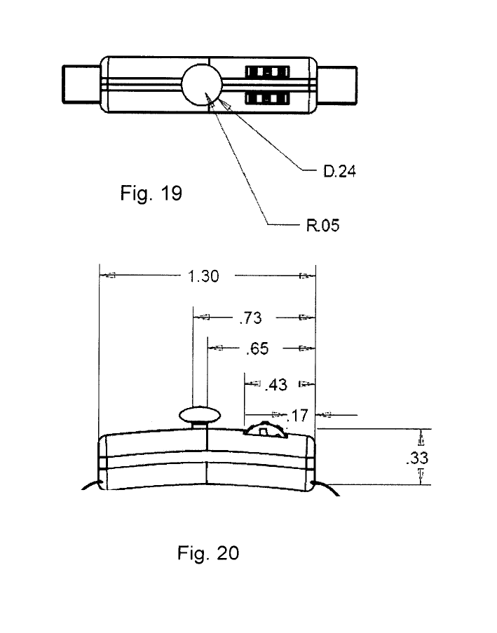

FIGS. 19-27 depict a preferred embodiment of a collar-attachable lock.

Rather than a collar-attachable lock for attaching to an existing pet collar, a lockable collar may be employed, which includes a pet collar with an attached or integral locking mechanism. The locking mechanism may be similar to the above-described collar-attachable locks that are secured by passing the hook of the collar padlock through an opening in the collar-attachable lock, or it could be a separate lock, for example a combination lock, built into the pet collar, and then the collar padlock may be attached to the collar using a separate collar connector.

Rather than a pet collar, the collar-attachable lock can be attached to an existing pet harness in the same way that it can be attached to a collar. Similarly, the lockable leash system could comprise a lockable pet harness, rather than a lockable collar.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention as will be evident to those skilled in the art.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

Words used in this description relating to the padlock that imply an orientation, such as “above”, “below”, “vertical”, “horizontal”, “highest”, “lowest”, “top” and “bottom”, are intended to be interpreted to refer to the orientations of the padlock depicted in FIGS. 2-5.

The scope of the claims that follow is not limited by the embodiments set forth in the description. The claims should be given the broadest purposive construction consistent with the description as a whole.

What is claimed is:

1. A padlock comprising:
(a) a shackle having first and second ends, the first and second ends being spaced apart;
(b) a locking pin having a longitudinal axis, a proximal end and a distal end, the locking pin engaging the first end of the shackle, the locking pin having a closed position in which the proximal end of the locking pin abuts the second end of the shackle so that the locking pin and the shackle together form a closed interior region, the locking pin being moveable relative to the shackle along the axis between the closed position and an open position in which the proximal end of the locking pin is spaced apart from the second end of the shackle to create an opening to the interior region; and
(c) a locking mechanism attached to the shackle, the locking mechanism having an unlocked configuration and one or more than one locked configuration,
wherein, when the locking pin is in the closed position and the locking mechanism is configured in one of the locked configurations, the locking pin is maintained in the closed position, and when the locking mechanism is configured in the unlocked position, the locking pin can be moved into the open position and, when in the open position, the locking pin can be moved into the closed position.

2. The padlock of claim 1, wherein a portion of the locking pin including the distal end is straight, a portion of the shackle defines a channel in the axial direction, the locking pin being disposed partly within the channel, the locking mechanism comprising a plurality of tumblers connected to the shackle, wherein the locking pin and tumblers are adapted so that, when the locking pin is in the closed position, the tumblers may be configured in one of the locked configurations, and wherein when the tumblers are configured in the unlocked position, the locking pin can slide into the open position.

3. The padlock of claim 2, wherein the second end of the shackle is further from the first end of the shackle than is the proximal end of the locking pin, and when the locking pin is moved from a closed position to an open position, the locking pin slides further into the channel.

4. The padlock of claim 2, wherein the proximal end of the locking pin is further from the first end of the shackle than is the second end of the shackle, and when the locking pin is moved from a closed position to an open position, the locking pin slides further out of the channel.

5. The padlock of claim 2, wherein each tumbler is rotatably attached to the shackle, each tumbler further comprises at least one notch on an inner wall, the locking pin has a protrusion for each tumbler, the protrusions being aligned along the axis of the locking pin so that the protrusions align with the notches in the tumblers when the tumblers are in the unlocked configuration, and wherein subsequent rotation of one or more than one tumbler, when the locking pin is in the closed position, configures the locking mechanism into one of the locked configurations.

6. The padlock of claim 2 further comprising a biasing mechanism for biasing the locking pin towards the closed position.

7. The padlock of claim 6 wherein the channel has a proximal end nearer the second end of the shackle, and a distal end further from the second end of the shackle, the shackle further comprises an end wall at the distal end of the channel, and the biasing mechanism comprises a spring having two ends, the spring being aligned along the axis and having one end in contact with the end wall of the channel and the other end in contact with the distal end of the locking pin.

8. The padlock of claim 1 wherein the locking pin is straight.

9. A lockable leash comprising a leash and a collar padlock, the collar padlock being the padlock of claim 1, the leash having a collar end and a handhold end, wherein the collar end of the leash is attached to the collar padlock.

10. The lockable leash of claim 9 further comprising a leash padlock, wherein the leash padlock is attached to the leash.

11. The lockable leash of claim 10, wherein the leash padlock is the padlock of claim 1.

12. The lockable leash of claim 11, wherein the leash padlock is identical to the collar padlock.

13. The lockable leash of claim 10 wherein the leash padlock is attached to the handhold end of the leash.

14. The lockable leash of claim 10 further comprising a leash connector attached to the leash, the leash connector defining an interior closed region, and wherein a portion of the leash connector is adapted to fit through the opening to the interior region of the leash padlock when the leash padlock is in the open position.

15. The lockable leash of claim 10 further comprising a plurality of leash connectors attached to the leash and spaced apart from each other, each leash connector defining an interior closed region, and wherein a portion of each leash connector is adapted to fit through the opening to the interior region of the leash padlock when the leash padlock is in the open position.

16. The lockable leash of claim 10 further comprising a leash connector surrounding the leash adapted to slide along the leash between the collar padlock and the leash padlock, the leash connector being a closed metal loop having an interior region sized to prevent the leash connector from moving past either padlock attached to the leash.

17. The lockable leash of claim 9 wherein the leash is made of a cut-resistant material.

18. The lockable leash of claim 17 wherein the leash comprises a metal chain comprising links.

19. The lockable leash of claim 18 wherein at least one link comprises a portion adapted to fit through the opening to the interior region of the leash padlock when the leash padlock is in the open position.

20. The lockable leash of claim 19 wherein each link comprises a portion adapted to fit through the opening to the interior region of the leash padlock when the leash padlock is in the open position.

21. A lockable leash system comprising the lockable leash of any one of claims 9 to 20 and a collar-attachable lock adapted to be attached to a pet collar or a pet harness.

22. A lockable leash system comprising the lockable leash of any one of claims 9 to 20 and a lockable pet collar.

23. A lockable leash system comprising the lockable leash of any one of claims 9 to 20 and a lockable pet harness.
